(19) United States
(12) Patent Application Publication
(10) Pub. No.: US 2007/0275742 A1
(43) Pub. Date: Nov. 29, 2007

(54) Method and system for data transmission of multimedia broadcast/multicast service

(76) Inventor: Hai Zhang, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/639,628

(22) Filed: Dec. 15, 2006

Related U.S. Application Data
(63) Continuation of application No. PCT/CN05/01125, filed on Jul. 26, 2005.

(30) Foreign Application Priority Data
Jul. 26, 2004 (CN) 200410070799.8
Aug. 14, 2004 (CN) 200410056142.6

(51) Int. Cl. H04Q 7/20; H04Q 7/24

(52) U.S. Cl. 455/466; 370/338

(57) ABSTRACT

A method for transmitting Multimedia Broadcast/Multicast Service (MBMS) data, comprising: sending, by a Broadcast/Multicast-Service Center (BM-SC), a Session Start Request with information of an MBMS service area to a Base Station Controller/Radio Network Controller (BSC/RNC) through a Gateway GPRS Support Node (GGSN) and a Serving GPRS Support Nodes (SGSN) of a core network; receiving the Session Start Request by the BSC/RNC, and building an Iu bearer plane by the core network and the BSC/RNC whose covering area overlaps the MBMS service area in the Session Start Request; allocating transmission resources for a data transmission of a MBMS service by the BSC/RNC whose covering area overlaps the MBMS service area in the Session Start Request, so as to provide the MBMS service to a user terminal. And the present invention also provides a system for implementing the method.

### FIELD OF THE INVENTION

The invention relates to the technique of data transmission, and particularly, to a method and system for transmitting the data of the Multimedia Broadcast/Multicast Service.

### BACKGROUND OF THE INVENTION

With development of the third generation (3G) mobile communication technology, 3G mobile communication can provide services with higher data rate than the second generation mobile communication and thus support various types of services, such as video telephone, graphic download, high-speed internet surfing, etc. And one kind of such services is characterized in transferring the service simultaneously to all its subscribers in a wireless network, e.g., weather forecast, news clips, collection of sports game, etc. Thus the concept of broadcast/multicast is introduced into 3G mobile communication.

Refer to FIG. 1, for an intermediate node such as node 10, the upstream node of node 10 sends only one set of data to node 10 no matter how many downstream nodes of node 10 are expecting the data; after receiving the data, node 10 replicates them based on the number of its downstream nodes which are expecting the data, and sends a set of the data to each of these downstream nodes, for example, node 101 and 102 are the downstream nodes of node 10 and are expecting the data, therefore node 10 reproduces two sets of the received data. In this way, every branch of the data transmission tree of broadcast/multicast service transfers only one set of data and occupies only one share of transmission resources, and so does the data transmission between the root node and its corresponding downstream nodes. The difference between multicast service and broadcast service is that a multicast service provider sends corresponding information only to the subscribers of certain information while a broadcast service provider sends information to all the users in the wireless network. It can be concluded from the above description that through sending the same information to multiple users simultaneously, broadcast/multicast service can save a lot of network resources.

FIG. 2 is a schematic diagram illustrating the structure of a wireless network with support to broadcast/multicast 'service. It is shown in FIG. 2 that in the 3G Partner Project (3GPP) of the prior art, the supporting unit of broadcast/multicast service in a wireless network is the Broadcast/Multicast Service Center (BM-SC) 201, which is connected to the Traffic Plane Function (TPF) Gateway GPRS Support Node (GGSN) 202 through Gmb interface or Gi interface. A BM-SC 201 may be connected to a number of the TPF GGSNs 202, each of which is connected to one or several Serving GPRS Support Nodes (SGSN) 203 through Gn/Gp interface. The SGSN 203 is connected to the Universal Mobile Telecommunications System (UMTS) Terrestrial Radio Access Network (UTRAN) 204 through Iu interface. The UTRAN 204 is connected to the User Equipment (UE) 206 through Uu interface. The SGSN 203 may alternatively be connected to the GSM/EDGE radio access network (GERAN) 205 of the Global System for Mobile communications (GSM) through Iu/Gb interface, and then GERAN 205 is connected to the UE 207 through Um interface. Among the above nodes, the GGSNs and the SGSNs are in the Core Network (CN) of the wireless network.

In a network illustrated by FIG. 2, a user subscribes to an MBMS service through an MBMS activation process such that the network may record the user who wants to receive a certain MBMS service. Through the MBMS registration processes the network nodes set up a transmission distribution tree from the BM-SC to a Base Station Controller/Radio Network Controller (BSC/RNC) through a GGSN and an SGSN such that the properties of an MBMS session and the data thereof could be allowed to be transferred. The MBMS bearer context is built in the related nodes during the registration procedure, but bearer plane is not built.

The BM-SC triggers the MBMS Session Start Procedure when it is ready for transmitting data, then the MBMS Session Start Procedure activates all the bearer resources in the network needed for transmitting the MBMS service data and informs the interested UE of the upcoming start of the data transmission. The BM-SC provides the session attributes such as the Quality of Service (QoS) of the MBMS service, the service area of the MBMS service, and the estimated session length that may exist, to the relevant interested network nodes through the MBMS Session Start Procedure. Some operations, such as the related RNC sending session notification in the access network, counting the number of users in cells, choosing the type of radio bearer and building the radio and cabled bearer plane, are also initiated by the MBMS Session Start Procedure. The BM-SC starts the multicast data transmission after the downstream nodes complete the related operations. Each node transmits the multicast data to UE by using the bearer built in the Session Start Procedure.

As shown in FIG. 3, the MBMS Session Start Procedure in the prior art comprises the following steps.

Step 301: the BM-SC sends a Session Start Request to a GGSN saved in the “downlink stream nodes list” parameter in its corresponding MBMS bearer context, which indicates that the transmission is about to start, and sets the state attribute of the MBMS bearer context as “Activate”. The request includes the session attributes such as the QoS, the service area of the MBMS and the estimated session length.

Upon receiving the Session Start Request, the GGSN saves the session attributes provided in the message in the MBMS bearer context and sets the state attribute of the MBMS bearer context as “Activate”, then returns a Session Start Response to the BM-SC.

Step 302: the GGSN sends the MBMS Session Start Request to the SGSN saved in the “downlink stream nodes list” parameter in its corresponding MBMS bearer context.

After receiving the MBMS Session Start Request, the SGSN saves the session attributes in the MBMS bearer context and sets the state attribute of the MBMS bearer context as “Activate”, then returns an MBMS Session Start Response to the GGSN so that the GGSN sends the MBMS service data, wherein the MBMS Session Start Response provides a Tunnel Egress Identifier (TEID) used for the bearer plane.

Step 303: the SGSN sends the MBMS Session Start Request including the session attributes to each BSC/RNC connected with the SGSN itself.

After receiving the MBMS Session Start Request, the BSC/RNC determines whether it is in the MBMS service area. If the BSC/RNC is in the MBMS service area, it saves the session attributes in the MBMS bearer context and sets the state attribute of the MBMS bearer context as “Activate” first, then returns an MBMS Session Start Response to the SGSN. Otherwise, the BSC/RNC returns the MBMS Session Start Response to the SGSN directly.

In this step, if the BSC/RNC is in the MBMS service area, the MBMS Session Start Response includes the TEID which is used for the Iu bearer plane for the SGSN to send the MBMS service data. Furthermore, if a BSC/RNC receives a number of MBMS Session Start Requests with the parameters of the Iu bearer plane, the BSC/RNC returns only one successful MBMS Session Start Response used for building one Iu bearer plane reaching the SGSN.

If the BSC/RNC is not in the MBMS service area, the MBMS Session Start Response returned by the BSC/RNC to the SGSN indicates that the BSC/RNC is not in the MBMS service area.

Step 304: The BSC/RNC in the MBMS service area sets up necessary radio resources used for transmitting the MBMS service data to the interested UE.

For the MBMS broadcast service, because the information of the broadcast service is sent to all the users in the radio network, each network node does not need to perform the MBMS registration procedure. When a BM-SC is ready for sending the data, it triggers an MBMS Session Start Procedure which activates all the bearer resources needed for transmitting the MBMS service data. The BM-SC provides the session attributes such as the TMGI, the QoS, the MBMS service area and the estimated session length that may exist to the relevant interested network nodes by the MBMS Session Start Procedure. Some operations, such as building the radio and cabled bearer plane, are also initiated by the MBMS Session Start Procedure. The BM-SC starts the broadcast data transmission after the downstream nodes complete the corresponding operations. Each node transmits the broadcast data to UE by using the bearer set up in the Session Start Procedure.

The MBMS broadcast service Session Start Procedure in the prior art is basically similar to the Session Start Procedure of MBMS multicast service. Also as shown in FIG. 3, the procedure comprises the following steps. Herein, Steps 301-304 are changed to Steps 301′-304′.

Step 301′: the BM-SC sends a Session Start Request to a GGSN in the Public Land Mobile Network (PLMN), which indicates that the transmission is about to start, and sets the state attribute of the MBMS bearer context as “Activate”. The request includes the session attributes such as the Temporary Mobile Group Identifier (TMGI), the QoS, and the MBMS service area.

Upon receiving the Session Start Request, the GGSN sets up an MBMS bearer context and saves the session attributes provided in the message in the MBMS bearer context, then, sets the state attribute of the MBMS bearer context as “Activate” and returns a Session Start Response to the BM-SC.

Step 302′: the GGSN sends the MBMS Session Start Request to all the SGSNs connected with the GGSN.

After receiving the MBMS Session Start Request, the SGSN sets up an MBMS bearer context and saves the session attributes in the MBMS bearer context and sets the state attribute of the MBMS bearer context as “Activate”, then returns an MBMS Session Start Response which provides the TEID used for the bearer plane to the GGSN so that the GGSN sends the MBMS service data.

Step 303′: the SGSN sends the MBMS Session Start Request including the session attributes to each BSC/RNC connected with the SGSN.

After receiving the Session Start Request, the BSC/RNC determines whether the BSC/RNC is in the MBMS service area. If the BSC/RNC is in the MBMS service area, the BSC/RNC sets up an MBMS bearer context and saves the session attributes in the MBMS bearer context and sets the state attribute of the MBMS bearer context as “Activate” first, then returns an MBMS Session Start Response to the SGSN. Otherwise, the BSC/RNC returns an MBMS Session Start Response to the SGSN directly.

In this step, if the BSC/RNC is in the MBMS service area, the MBMS Session Start Response of the BSC/RNC includes the TEID which is used for the Iu bearer plane for the SGSN to send the MBMS service data. Furthermore, if a BSC/RNC receives a number of MBMS Session Start Requests with the parameters of the Iu bearer plane, the BSC/RNC returns only one successful MBMS Session Start Response used to build one Iu bearer plane reaching the SGSN.

If the BSC/RNC is not in the MBMS service area, the MBMS Session Start Response sent by the BSC/RNC to the SGSN indicates that the BSC/RNC is not in the MBMS service area.

Step 304′: The BSC/RNC in the MBMS service area sets up necessary radio resources used for transmitting the MBMS service data to the interested UE.

As seen from the above specific procedure, the SGSN sends an MBMS Session Start Request including the session attributes to each of BSC/RNCs connected with the SGSN in the Session Start Procedure. The BSC/RNC in the MBMS service area saves the session attributes in the MBMS service context, sets the state attribute of the MBMS service context as “Activate”, and then returns an MBMS Session Start Response to the SGSN. The BSC/RNC which is not in the MBMS service area returns an MBMS Session Start Response which indicates that the BSC/RNC is not in the MBMS service area to the SGSN directly.

The MBMS service area of the above MBMS service is fixed, namely, the MBMS service area of the MBMS service is unchanged.

### SUMMARY OF THE INVENTION

This invention provides a method and a system for transmitting multimedia broadcast/multicast service data.

The technical solution is as follows.

A method for transmitting Multimedia Broadcast/Multicast Service (MBMS) data, includes the following processes:

a BM-SC sends a Session Start Request with information of an MBMS service area to a BSC/RNC through a GGSN and a SGSN of a core network;

the BSC/RNC receives the Session Start Request, and the core network and the BSC/RNC whose covering area overlaps the MBMS service area in the Session Start Request build an Iu bearer plane;

the BSC/RNC whose covering area overlaps the MBMS service area in the Session Start Request allocates transmission resources for a data transmission of a MBMS service by, so as to provide the MBMS service to a user terminal.

A system for transmitting Multimedia Broadcast/Multicast Service (MBMS) data, includes a BM-SC, a GGSN, a SGSN, BSC/RNC, and

the BM-SC is used for sending a Session Start Request to a BSC/RNC through a GGSN and a SGSN of a core network;

the GGSN is used for receiving the Session Start Request from the BM-SC, and forwarding the Session Start Request to the SGSN;

the SGSN is used for receiving the Session Start Request from the GGSN, and sending the Session Start Request to the BSC/RNC;

the BSC/RNC is used for building an Iu bearer plane and allocating transmission resources for a data transmission of a MBMS service according to the Session Start Request;

and the BM-SC is configure to obtain information of an MBMS service area, and send the information of an MBMS service area to the BSC/RNC through the core network;

and the BSC/RNC builds the Iu bearer plane and allocates transmission resources for the data transmission of the MBMS service according to the information of the MBMS service area and a covering area of itself.

### BRIEF DESCRIPTION OF THE DRAWINGS

FIG. 1 is a schematic illustrating the transmission principle of a multicast service.

FIG. 2 is a schematic illustrating the architecture of a radio network supporting broadcast/multicast services.

FIG. 3 is a schematic flow chart of the MBMS Session Start Procedure in the prior art.

FIG. 4 is a schematic flow chart of an embodiment of the method for transmitting MBMS service data in accordance with this invention.

FIG. 5 is a schematic flow chart of another embodiment of the method for transmitting MBMS service data in accordance with this invention.

FIG. 6 is a schematic illustrating the network topology of an embodiment of this invention.

FIG. 7 is a schematic illustrating a network topology of another embodiment of this invention.

FIG. 8 is a schematic illustrating another network topology of another embodiment of this invention.

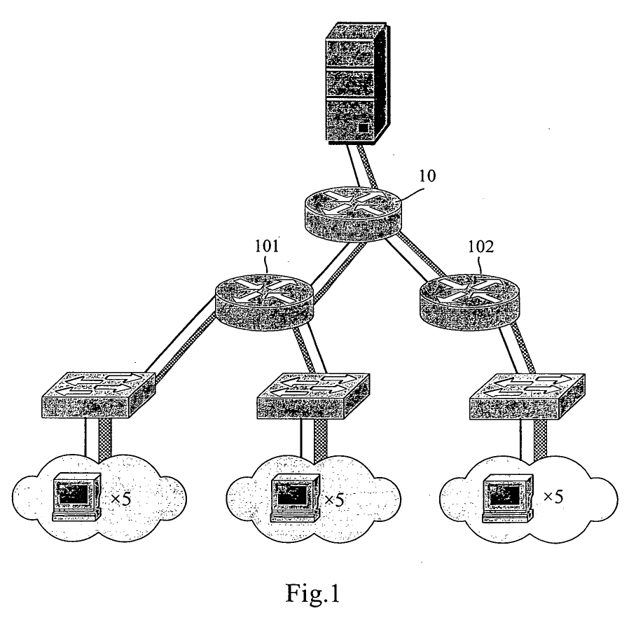

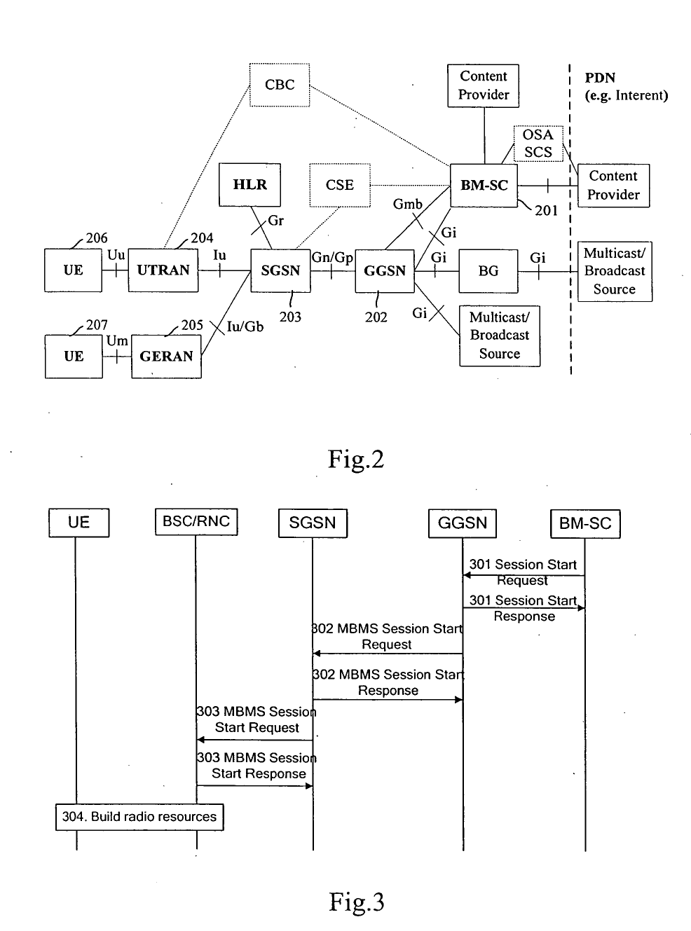

### DETAILED DESCRIPTION OF PREFERRED EMBODIMENTS

A fixed MBMS service area goes against the use of some MBMS bearers in practice. For example, for a country wide weather forecast service adopting the MBMS bearer transmission, a user in a city only cares about the weather of that city. Suppose that a user is in the city of Beijing, he only cares about the weather of Beijing, but when the user moves to the city of Tianjin, he will start to care about the weather of Tianjin.

If the existing method of a fixed MBMS service area is adopted, there are two solutions. One is to send a country wide weather to country wide users; the other is that the user moving to the city of Tianjin reapplies for the MBMS service of the weather forecast of Tianjin. Much resource are wasted in the first solution because most users only care about the weather of the local region while in the second solution, users becomes unsatisfied because the users need to reapply for the MBMS service.

Additionally, for the practical conditions of a radio network, the bearer capability of each cell is different. If a high QoS is adopted to transmit data in a large region, the data cannot be transmitted in some parts of the region as a result. But if data are transmitted with smaller bandwidth according to the need of cells with relatively low bearer capabilities, the bearer capabilities of many other cells will not be fully used and the time for sending the multicast data is prolonged.

Thus, this invention is implemented by that: a BM-SC sends the MBMS service area and the related information to a BSC/RNC through a GGSN and a SGSN of a core network; the BSC/RNC determines the final service area of a certain MBMS session of the MBMS service according to its own covering area of cells. Herein, before the content provider sends the MBMS service area and related information of each session the GGSN and the SGSN of the core network, the BM-SC may triggers the sending of the Session Start Request, or the third part triggers the sending, and the third part may be a content provider. When the content provider triggers the BM-SC to send information of MBMS service area, there are two cases of the content provider sending the related information of MBMS service area of a certain MBMS session to the BM-SC. One is that the content provider sends the information of MBMS service area of a certain session to the BM-SC initiatively. The other is that the content provider provides the MBMS service area and the related information as required by the BM-SC. In the following description, take the case that the content provider triggers the BM-SC to send information of MBMS service area for example, the other manners of triggering the BM-SC to send information are similar to the manner of content provider triggering the BM-SC to send information, and the other manners are not described in detail hereinafter.

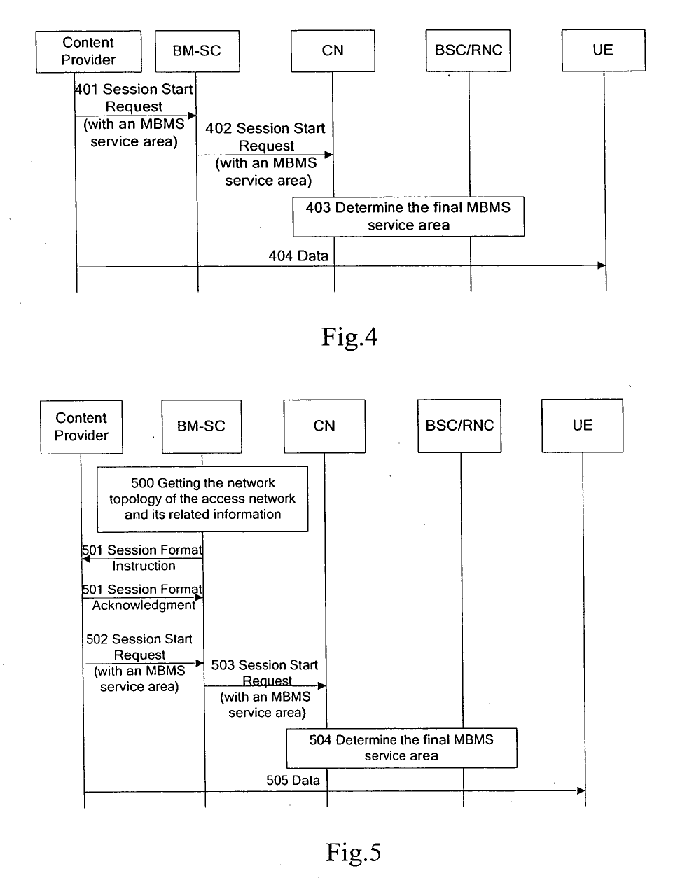

In the first case of the content provider sending the related information of MBMS service area to the BM-SC, the specific procedure of MBMS service data transmission comprises the following steps as shown in FIG. 4.

Step 401: before a session starts, a content provider sends a Session Start Request which includes parameters, such as the QoS, the MBMS service area, the expected session length and the MBMS service identifier, to a BM-SC.

The QoS is used for identifying the quality of service needed in the session and the transmission rate of sending the service data. The MBMS service area is used for identifying the covering area of the session, which can be represented by geographical information such as longitude and latitude. The parameter of MBMS service area is defined by the content provider, and is independent to each session, namely, the MBMS service area parameters of different sessions of one MBMS bearer can be different. The expected session length is used for indicating the time duration of the session. The MBMS service identifier is used for identifying the MBMS service, which can be the IP address of the multicast, or a service code assigned to the content provider by the operator. Herein, a content provider is an entity which provides a MBMS service for users.

Step 402: after receiving the Session Start Request sent by the content provider, the BM-SC sends the Session Start Request to a GGSN in the CN;

the Session Start Request includes parameters similar to the parameters in the step 401, such as the QoS, the MBMS service area, the expected session length and the MBMS service identifier.

Step 403: the GGSN in the CN then sends the Session Start Request to an SGSN, and the SGSN sends the Session Start Request to all the BSC/RNCs connected with the SGSN after receiving the message.

Each of the BSC/RNCs that receive the Session Start Request compares the MBMS service area in the request message with its own covering area to find whether there is overlap. If there is overlap, the BSC/RNC builds an Iu bearer plane between itself and the SSGN, and builds the corresponding Iub bearer, the corresponding radio bearer with the base station corresponding to the overlap area and allocates appropriate transmission resources. Otherwise, the BSC/RNC returns a Session Rejection to the SGSN without building the corresponding bearers, and terminates the current procedure of data transmission.

Herein, if there are a number of overlap cells and the transmission bearer capabilities of the cells are different, the data transmission of the current MBMS service in different areas can be performed via multiple sessions, respectively, by adopting appropriate transmission bearer capabilities of the different areas.

Step 404: the content provider provides the MBMS service data for the UE which needs the MBMS service. Specifically, the MBMS service data of this MBMS session is transmitted using the allocated corresponding resources through the built cabled and radio bearer along the nodes having build the bearer plane.

In the second case of the content provider providing the related information of MBMS service area to the BM-SC, the specific procedure of the MBMS service data transmission comprises the following steps as shown in FIG. 5.

Step 500: The BM-SC gets the information of network topology corresponding to transmitting capability of the access network side according to the transmission capability of the access network, wherein the information includes not only the communication network composition of the access network, but also the information of the QoS supported by each area, including at least the transmission rate for sending service data.

Herein, there are two manners of the BM-SC getting the network topology information: a) the BSC/RNC in the access network reports the current load of each cell to the BM-SC as scheduled or in the manner required by the BM-SC. Thus, the BM-SC can acquire at any time the QoS of the MBMS service supported by the current radio network. This kind of network topology information can be called a cell bearer network topology. b) the corresponding network configuration information is saved in the BM-SC when network planning is made, wherein the configuration information includes at least the network composition of each area and the QoS which the area supports, such as the network type of an area and the transmission rate it supports, etc. This kind of network topology can be called a planned network topology.

Regarding the same QoS, the BM-SC can learn that the current radio network can support each network topology structure of different QoS from the information saved in itself by getting the intersection between the above two network topologies.

Step 501: before a session starts, the BM-SC sends to the content provider the required Session Format Instruction, which includes at least the parameters, such as the QoS required by the MBMS service data of the session, the MBMS service identifier, and the session format, wherein the QoS required in the session of the MBMS service data is determined according to the access network area in which the session will be transmitted, and the QoS includes the information such as transmission rate; the MBMS service identifier defines the MBMS service, which can be the IP address of the multicast, or a service code assigned to the content provider by the operator; the session format can define the format required in the session, such as audio, video and etc. After receiving the Session Format Instruction, the content provider returns a Session Format Acknowledgment for the corresponding Session Format Instruction. The Session Format Instruction is used for requiring the content provider to provide the MBMS session data according to this session format.

Step 502: a content provider sends a Session Start Request including parameters, such as the QoS, the MBMS service area, the expected session length and the MBMS service identifier, to a BM-SC according to the service required by the BM-SC in Step 501. The QoS herein is used for identifying the quality of service needed in the session. The MBMS service area is used for identifying the covering area of the session, which can be represented by geographical information such as longitude and latitude, and is independent to each session; namely, the MBMS service area parameters of different sessions of one MBMS can be different. The expected session length is used for indicating the time duration of the session. The MBMS service identifier is used for identifying the MBMS service, which can be the IP address of the multicast, or a service code assigned to the content provider by the operator.

Upon receiving the Session Start Request, the BM-SC gets the intersection between the geographical area defined by itself according to the QoS and the geographical area corresponding to the MBMS service area in the received Session Start Request, and determines the information of geographical area which will be eventually transmitted by the session.

Step 503-504 are the same as steps 402 and 403 in the first case of the content provider providing the related information of MBMS service area for the BM-SC.

Step 505: Upon setting up the Iu bearer plane and the resources of the Iub bearer and corresponding radio bearer, when providing the corresponding MBMS session, the content provider provides the MBMS service data for UE according to the MBMS session requirement made by the BM-SC in Step 501, and the MBMS service data are transmitted along the corresponding bearer plane set up by using the corresponding radio bearer resources.

In the above two solutions, the BM-SC may provide the GGSN with different information of MBMS service area for different sessions of one MBMS service.

In the above two solutions, the BSC/RNC determines the geographical information of the final MBMS service area according to the received information of MBMS service area and the information of its own covering area. In practice, there are two forms of information of MBMS service area in the Session Start Request when the BM-SC sends the MBMS Session Start Request. Accordingly, the corresponding contents compared by the BSC/RNC are different.

\textcircled{1} The BM-SC transmits the obtained geographical information of the MBMS service area through the Session Start Request message, namely, the BM-SC sends the geographical information of the MBMS service area to all the BSC/RNCs connected with the SGSN through the GGSN and the SGSN. Upon receiving the Session Start Request, each BSC/RNC gets the list of overlapping cells between the geographical area of its own covering cells and the geographical area of the MBMS service area by comparing the geographical information of the MBMS service area with the corresponding geographical information of its own covering cells.

\textcircled{2} the BM-SC sends the obtained geographical information of MBMS service area to a server storing the network configuration, and the server compares the geographical information of MBMS service area provided by the BM-SC with the covering area of the radio network, and gets the list of cells in the radio network corresponding to the provided geographical information of MBMS service area according to the corresponding relation. Then, the server returns the obtained list of cells to the BM-SC. So, when the BM-SC sends a Session Start Request to the CN in the MBMS service data transmission procedure as shown in FIG. 4, the information of MBMS service area being transmitted is the list of cells obtained by the BM-SC, and the list of cells is transmitted to all the BSC/RNCs connected with the SGSN through the GGSN and the SGSN in the CN. Upon receiving the Session Start Request, each BSC/RNC still performs the comparison of the service areas, and in this case, it is to compare its own covering cells with the cells in the list of cells directly, and get the overlapping cells. Herein, the server can be an independent network entity, or a function entity inside the BM-SC.

In the second solution, because a list of cells is carried in the Session Start Request message sent by the BM-SC to the GGSN, the GGSN or the SGSN receiving the Session Start Request can determine directly whether their own covering geographical areas include the cells in the list of cells. If the GGSN or the SGSN own covering geographical areas include the cells in the list of cells, the GGSN or the SGSN continue to send the Session Start Request to the downstream nodes. If not, the GGSN or the SGSN returns a Session Rejection to their upstream nodes without building the corresponding bearer, and terminates the current data transmission procedure. Furthermore, the GGSN or the SGSN will no longer send the Session Start Request to the downstream nodes thereof.

In the above two solutions of the BM-SC sending information of MBMS service area of different forms, there are two sources from which the BM-SC gets the information of MBMS service area.

The first source, the information of MBMS service area that the BM-SC gets is the geographical information of MBMS service area that the content provider sends.

The second source, the BM-SC gets the information of MBMS service area by the following steps: the BM-SC first gets the intersection between the cell bearer topology which the BM-SC obtains currently and the planned network topology according to the QoS parameter of the same type supported by the network; then requires the content provider to send data of the corresponding session format according to the obtained intersection. After the content provider sends the Session Start Request with the information of MBMS service area to the BM-SC according to the Session Format Instruction, the BM-SC gets the intersection between the previously obtained topology intersection and the information of MBMS service area in the Session Start Request, and gets the MBMS area to be sent by the session. Then, the BM-SC sends the obtained MBMS service area to the GGSN, or the BM-SC sends the obtained MBMS service area to a server storing the network configuration. The topology intersection obtained first can be a cell bearer topology, or planned network topology, or the whole network. For example, provided that Area A includes three parts, namely, Area A1, Area A2 and Area A3, wherein Area A1 and Area A2 are the covering areas of a WCDMA network which supports a transmission bearer capability of 384 kbps, Area A3 is a covering area of a GPRS network which supports a transmission bearer capability of 64 kbps. According to the load of the bearers, the current available bearer capabilities of the areas are listed as the following: the current transmission bearer capability of Area A1 is 100 kbps, A2 is 180˜250 kbps, and A3 is 30 kbps. Therefore, the BM-SC determines that Area A1 can transmit a MBMS service of 100 kpbs, Area A2 200 kbps, and Area A3 30 kbps. So, the BM-SC asks the content provider for MBMS services of 100 kbps, 200 kbps and 30 kbps, respectively. The content provider sends different Session Start Requests, in which the transmission rates are 100 kbps, 200 kbps and 30 kbps and the MBMS service area is the entire Area A, according to the requirements of the BM-SC. Then, the BM-SC gets the intersection between the areas of different bearer capabilities and Area A, and determines the three areas to which the three MBMS sessions will be sent are Area A1, Area A2 and Area A3, namely, the session of 100 kbps transmission rate will be transmitted in Area A1, the session of 200 kbps transmission rate will be transmitted in Area A2, and the session of 30 kbps transmission rate will be transmitted in Area A3.

Obviously, when the BM-SC sends an MBMS service area to the downstream nodes, it can send the geographical information of the MBMS service area directly, which is equivalent to sending a copy of geographical map to the downstream nodes. Alternatively, the BM-SC can transform the geographical information of the MBMS service area into the information of a list of cells and send the transformed geographical information to the downstream nodes.

Because both the 2G access network, GSM/EDGE Radio Access Network (GERAN) in which the entity connected with the SGSN is a BSC, and the 3G access network, Universal Terrestrial Radio Access Network (UTRAN) in which the entity connected with the SGSN is an RNC, support the MBMS simultaneously and can be connected to the existing CN in the present network topology. A 2G or 3G network identifier can be carried in a Session Start Request by a BM-SC when satisfying the demands of different network capabilities using different sessions. And the SGSN can decide to send a Session Start Request to a BSC or an RNC according to the 2G or 3G network identifier after receiving the Session Start Request. Based on this idea, this preferred embodiment can provide another solution, namely, on the basis of the two solutions of the content provider providing the related information of MBMS service area to the BM-SC, the BM-SC sends a network type identifier of access network required by a certain session to the GGSN, which indicates whether to adopt a 2G network or a 3G network. The network type identifier of access network can be determined by negotiation between the content provider and the BM-SC in advance, or determined by the content provider through negotiation according to the Session Format Instruction of the BM-SC.

Specifically, in Step 401 of the first case of the content provider providing the related information of MBMS service area to the BM-SC, besides the existing information, a Session Start Request sent by the content provider to the BM-SC further carries a network type identifier of access network used for identifying the type of the access network in which the session needs to be transmitted. Correspondingly, the BM-SC will sends the network type identifier of the access network to the GGSN and the SGSN; in Step 403, the SGSN will decide whether to send the Session Start Request to a BSC, or to an RNC, or to both of them according to the network type identifier of access network; the BSC/RNC receiving the Session Start Request continues with the subsequent operation.

In the second case of the content provider providing the related information of MBMS service area to the BM-SC, Step 500 is deleted and Step 505 keeps unchanged. The other steps are changed as the following.

Step 501′: before a session starts, the BM-SC sends the required Session Format Instruction including at least the parameters, such as the QoS required by the MBMS service data of the session, the MBMS service identifier and the session format, to the content provider. The QoS required by the MBMS service data in the session is determined according to the access network in which the session needs to be transmitted, and the QoS includes such information as transmission rate; the MBMS service identifier defines the MBMS service, which can be the IP address of the multicast, or a service code assigned to the content provider by the operator; the session format can define the format required in the session, such as audio, video, etc. Upon receiving the Session Format Instruction, the content provider returns a Session Format Acknowledgment for the corresponding Session Format Instruction. The Session Format Instruction is used for requiring the content provider to provide the MBMS session data according to this session format.

When the BM-SC sends the required Session Format Instruction to the content provider, the Session Format Instruction carries the type of the network in which the session needs to be transmitted, namely a 2G network or a 3G network. According to the configuration in advance, the content provider gets the related information corresponding to the network type, such as the requirement for the QoS, the range of the supported rate, etc., then returns the obtained information of the matched corresponding network to the BM-SC.

Step 502′: the content provider sends a Session Start Request which includes such parameters as the QoS, the MBMS service area, the expected session length and the MBMS service identifier to a BM-SC according to the service required by the BM-SC in Step 501′. The QoS is used for identifying the quality of service needed in the session. The MBMS service area is used for identifying the covering area of the session, which can be represented by geographical information such as longitude and latitude. The parameter of MBMS service area is independent to each session, namely, the MBMS service area parameters of different sessions of one MBMS can be different. The expected session length is used for indicating the time duration of the session. The MBMS service identifier is used for identifying the MBMS service, which can be the IP address of the multicast, or a service code assigned to the content provider by the operator. The network type identifier of access network is used for identifying the type of the access network in which the session needs to be transmitted.

Upon receiving the Session Start Request, the BM-SC gets the intersection between the geographical area defined by itself according to the QoS and the geographical area corresponding to the MBMS service area in the received Session Start Request, and determines the geographical area information which will be eventually transmitted by the session.

Step 503′: after receiving the Session Start Request sent by the content provider, the BM-SC sends a Session Start Request with the network type identifier of access network to a GGSN in the CN.

Step 504′: the GGSN in the CN sends the Session Start Request with the network type identifier of access network to the SGSN.

Upon receiving the message, the SGSN determines the BSC/RNC connected with the SGSN and decides which BSC/RNC in the access network to send the Session Start Request according to the network type identifier of access network. Specifically, if the network type identifier of access network indicates a 2G network, it sends the Session Start Request only to the BSC; if the network type identifier of access network indicates a 3G network, it sends the Session Start Request only to the RNC; if the network type identifier of access network indicates both a 2G network and a 3G network, it sends the Session Start Request to all the BSC/RNCs connected with itself.

Each BSC/RNC that receives the Session Start Request compares the MBMS service area in the request with its own covering area to find whether there is overlap. If there is overlap, the BSC/RNC builds an Iu bearer plane between itself and an SSGN, builds the corresponding Iub bearer and radio bearer with the base station corresponding to the overlap area, and allocates the appropriate transmission resources. Otherwise, the BSC/RNC returns a Session Rejection to the SGSN without building the corresponding bearers, and terminates the current procedure of data transmission.

Herein, if there are a number of overlapping cells and the transmission bearer capabilities of the cells are different, the data transmission of the current MBMS service in different areas can be performed through a number of sessions, respectively, by adopting appropriate transmission bearer capabilities of the different areas.

The above decision on the network type identifier of access network can also be performed in the BSC/RNC, namely:

Step 503″: upon receiving the Session Start Request sent by the content provider, the BM-SC sends a Session Start Request with the network type identifier of access network to a GGSN in the CN.

Step 504″: the GGSN in the CN sends the Session Start Request with the network type identifier of access network to an SGSN. Upon receiving the message, the SGSN sends the Session Start Request with the network type identifier of access network to all the BSC/RNCs connected with the SGSN.

Each of the BSC/RNCs which have received the Session Start Request compares the network type identifier of access network first. If the BSC/RNC does not belong to the network type of access network required in the session, the BSC/RNC does not continue the next operation and terminates the current processing procedure. Otherwise, the BSC/RNC continues to determine by comparison whether there is overlap between the MBMS service area in the request message and its own covering area. If there is overlap, the BSC/RNC builds an Iu bearer plane between itself and the SSGN, builds the corresponding Iub bearer and radio bearer with the base station corresponding to the overlap area, and allocates the corresponding transmission resources. If there is no overlap, the BSC/RNC returns a Session Rejection to the SGSN without building the corresponding bearer, and terminates the current data transmission procedure.

Herein, if there are a number of overlap cells and the transmission bearer capabilities of the cells are different, the data transmission of the current MBMS service in different areas can be performed through a number of sessions, respectively, by adopting appropriate transmission bearer capabilities of the different areas.

The following are some embodiments of the present invention, which make the advantages of the present invention more apparent.

### Embodiment 1

In this embodiment, a content provider initiatively sends to BM-SC the information of MBMS service area of the information to be issued, and the BSC/RNC decides the final service area of the MBMS service. In this embodiment, the content provider provides an MBMS service of traffic information of a city, and the MBMS service provides the local traffic information, such as real-time traffic broadcasting, real-time pictures and explication of traffic congestion, for the users of different regions of the city. The real-time traffic broadcasting is for the users of the whole city while the real-time pictures and explications of traffic congestion are to be issued only in the regions of congestion, for only the users in the regions of congestion care about the pictures and explications.

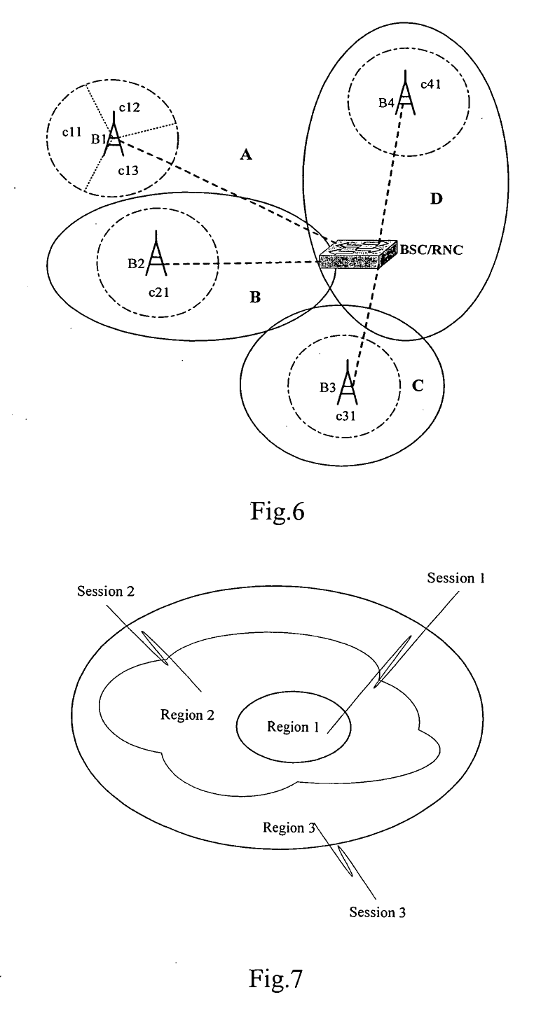

FIG. 6 is a schematic illustrating the network topology of the city in this embodiment. This embodiment further includes three application examples, all of which are as shown in FIG. 6. The city has four regions, namely Region A, Region B, Region C and Region D, as shown in FIG. 6. Meanwhile, there are four base stations of Node B, namely Node B1, Node B2, Node B3 and Node B4, in the city. All four Nodes B are connected with a BSC/RNC in the city. The four dash-dotted circles in FIG. 6 are the covering areas of the four Nodes B, respectively, wherein the covering area of Node B1 is divided into three cells, namely c11, c12 and c13, while the covering areas of the other three Nodes B have only one cell each, namely c21, c31, c41, respectively. Thus, all the cells, c11, c12, c13, c21, c31 and c41 are the cells covered by the BSC/RNC. Cells c21, c31 and c41 are located in Region B, C, and D, respectively, and part of cells c12 and c13 are located in Region A.

In the first application example, provided that the i^{th} MBMS session of the MBMS providing the city traffic information needs to broadcast real-time pictures and explications of local traffic congestion in Region A. In this case, the MBMS service data transmission procedure for issuing the real-time pictures and explications of traffic congestion is as follows.

11) The content provider sends a Session Start Request to the BM-SC. The request carries the geographical information of Region A in which the session needs to be broadcasted, the geographical information of Region A can be a region identified with longitude and latitude, and the request also carries the service code of the MBMS service.

12) Upon receiving the Session Start Request, the BM-SC transforms the geographical information in the request into a format which can be recognized by the BSC/RNC, then sends the Session Start Request with the geographical information of Region A to the GGSN. Next, the GGSN sends the Session Start Request with the geographical information of Region A to the SGSN. After receiving the Session Start Request, the SGSN sends the Session Start Request with the geographical information of Region A to all the BSC/RNCs connected with itself.

13) Upon receiving the Session Start Request, the BSC/RNC gets the information of MBMS service area, namely the geographical information of Region A, in the request message first; then, determines whether the geographical area covered by the cells governed by the BSC/RNC includes the area indicated by the above information of MBMS service area, that is to say, the BSC/RNC determines whether there is an intersection between the six cells covered by itself and Region A. An intersection exists because parts of Cell c12 and C13 are located in Region A. Thus, the BSC/RNC builds the corresponding Iu bearer plane with the SGSN. In this embodiment, other unqualified conditions including such abnormal conditions as the Iu Flax, network failure and etc., do not exist in the default case, that is to say, apart from the absence of an intersection, no other abnormal conditions exist.

14) The BSC/RNC having built the Iu bearer plane builds the Tub bearer with the corresponding Node B and builds the radio bearer resources in the corresponding cells according to the result of the above determining.

As shown in FIG. 6, among the four Nodes B covered by the BSC/RNC, there is overlap between the covering area of Cell c12 and c13 of Node B1 and Region A. Therefore, the BSC/RNC builds the Tub bearer with Node B1 in this step. The covering area of cells and the required geographical location cannot match perfectly because of the irregularity of the covering area of radio cells. So it is needed to determine a data transmission strategy, namely, transmitting the data according to a larger area, or according to a smaller area. If the strategy of transmitting the data according to a larger area is adopted, the data is transmitted in the whole cell. In this embodiment, the strategy of transmitting the data according to a larger area is adopted. So, the MBMS service is transmitted in the whole cell of Cell c13 although only part of the covering area of Cell c13 is within Region A, and the corresponding radio bearer resources are built in Cells c12 and c13.

15) After the Iub bearer and the corresponding radio bearer resource have been built, when the content provider provides the i^{th} session, the service data are transmitted through a series of built bearers and resources. Therefore, only Node B1 can receive the MBMS service of traffic information, and then the service is transmitted in Cells c12 and c13 which Node B1 covers.

In the second application example, provided that the j^{th} MBMS session for providing the city's traffic information needs to broadcast real-time pictures and explications of local traffic congestion in Region B. In this case, the MBMS service data transmission procedure for issuing real-time pictures and explications of traffic congestion is as follows.

21) The content provider sends a Session Start Request to the BM-SC. The request carries the geographical information of Region B in which the session needs to be broadcasted, the geographical information of Region B can be a region identified with longitude and latitude, and the request also carries the service code of the MBMS service.

22˜23) The processing procedure is the same as the application example 1 except that what the request carries is the geographical information of Region B. The BSC/RNC also determines whether there is overlap between its own covering cells and Region B.

24) The BSC/RNC having built the Iu bearer plane builds the Iu bearer with the corresponding Node B and builds the radio bearer resources in the corresponding cells according to the result of the above determining. As shown in FIG. 6, as the whole Cell of c21 is located in Region B, the BSC/RNC builds the Iub bearer between itself and Node B2 and builds the corresponding radio bearer resources in the Cell c21 of Node B2.

25) After the Iub bearer and the corresponding radio bearer resource have been built, the service data are transmitted through a series of the above built bearers and resources when the content provider provides the j^{th} session. In this case, only Node B2 can receive the corresponding MBMS service, then Node B2 transmits the service in Cell c21 which it covers.

In the third application example, provided that the k^{th} MBMS session for providing the city's traffic information needs to broadcast integrated traffic information of Regions A, B, C and D in these regions. Thus, according to the service data transmission procedures given in application example 1 and application example 2, the content provider sends the geographical information of Regions A, B, C and D to the BM-SC which sends the information to the BSC/RNC through the GGSN and the SGSN; next, the BSC/RNC in the access network builds the Iub bearers between itself and Node B1, B2, B3 and B4, and builds the corresponding radio bearer resources in Cell c12 of Node B1, Cell c21 of Node B2, Cell c31 of Node B3 and Cell c41 in Node B4.

After all the Iub bearers and the corresponding radio bearer resources have been built, the service data are transmitted through a series of built bearers and resources when the content provider provides the k^{th} session. In this example, Node B1, Node B2, Node B3 and Node B4 can all receive the MBMS service data, and then each of the Nodes B transmits the MBMS service data in its own cell in which the corresponding radio bearer resources have been built.

### Embodiment 2

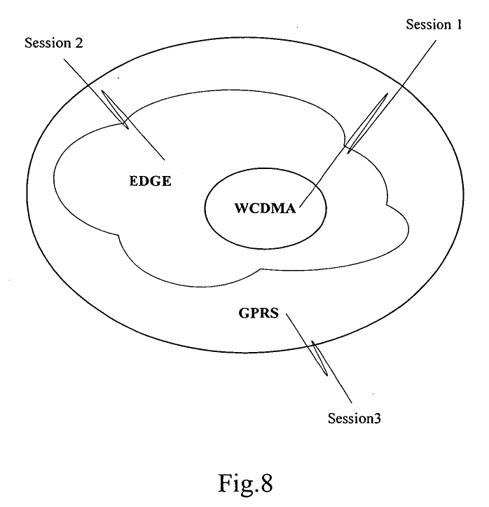

In this embodiment, the radio communication network of a city includes several conditions. FIG. 7 and FIG. 8 are two topology structures of the city radio communication network classified from different points of view. FIG. 7 is the topology structure classified according to the busy/idle state of services. FIG. 8 is the topology structure classified according to the modes which the networks support.

As shown in FIG. 7, the conditions of a city's radio communication network can be classified into three types: the core area of the city, Area1, in which the bandwidth that can be used for MBMS service data transmission is 64 kbps because of service congestion; the central area of the city, Area2, in which the bandwidth that can be used for MBMS service data transmission is 128 kbps because of better service condition; and the marginal area of the city, Area3, in which the bandwidth that can be used for the MBMS service data transmission is 384 kbps because of fewer users.

As shown in FIG. 8, the city radio communication network is composed of the networks supporting three modes, namely, the WCDMA network covering the core area of the city, the GPRS network covering the suburb, and the EDGE network covering the other areas. The MBMS service data transmission rates supported by the three kinds of network are different: the WCDMA network supports a rate of 384 kbps, the EDGE network supports 90 kbps, and the GPRS network supports 30 kbps.

In this embodiment, the BM-SC can acquire the information of the currently covering radio communication network in advance, such as the network condition, the network type and the transmission rate which the network supports. In the case as shown in FIG. 7, the BSC/RNC in the access network may report the current load of each cell to the BM-SC periodically or in a manner required by the BM-SC such that the BM-SC could acquire at any time the QoS of the MBMS service, namely, the transmission rate which the current radio network can support. In the case as shown in FIG. 8, the corresponding network configuration information may be saved in the BM-SC when the network planning is made such that the BM-SC could acquire the MBMS service data transmission rate which the corresponding area supports.

Specifically, this embodiment is to provide an MBMS download service in the above area, such as downloading a copy of a picture of 2 MB size, and the BSC/RNC determines the final service area of the MBMS service. Then, based on the radio communication network as shown in FIG. 7, there are the following application examples.

In the first application example, provided that the BM-SC needs to send the i^{th} MBMS session of the MBMS download service in the core area, Area1. Based on the comprehensive conditions of the radio network, the BM-SC needs to perform a data transmission of 64 kbps in Area1. Then, the data transmission procedure for the MBMS download service is as follows.

31) The BM-SC sends a Session Format Instruction which includes such parameters as the QoS information required in the session and the MBMS service identifier to the content provider. The QoS information required in the session is used for asking the content provider to send the multicast data at a rate of 64 kbps; the MBMS service identifier defines the MBMS service, which can be the IP address of the multicast, or a service code assigned to the content provider by the operator. Upon receiving the above Session Format Instruction, the content provider records the corresponding Session Format Instruction and returns a Session Format Acknowledgment to the BM-SC.

32) The content provider, according to the service required in the Session Format Instruction, sends to the BM-SC a Session Start Request, which includes such parameters as the QoS, the MBMS service area, the estimated session length and the MBMS service identifier.

The QoS indicates that the rate of the session is 64 kbps;the MBMS service area is the service issuing area defined by the content provider, which, herein, is the union of the three areas, namely, Area1+Area2+Area3; the estimated session length is used for indicating the time duration of the session; and the MBMS service identifier is used for identifying the MBMS service, which can be the IP address of the multicast, or a service code assigned to the content provider by the operator.

After receiving the Session Start Request with the above parameters, the BM-SC gets the intersection between the geographical area of Area1 defined by itself and the geographical area of Area1+Area2+Area3 in the received Session Start Request, and decides Area1 as the geographical area in which this session needs to be transmitted.

33) The BM-SC transforms the obtained geographical information into a format which can be recognized by the BSC/RNC, namely, transforms the geographical information of Area1 into the format which can be recognized by the BSC/RNC, then sends the Session Start Request with the geographical information of Area1 to the GGSN. Next, the GGSN sends the Session Start Request to the SGSN. Upon receiving the Session Start Request, the SGSN sends the Session Start Request with the geographical information of Area1 which can be recognized by the BSC/RNC to all the BSC/RNCs connected with the SGSN.

34) Upon receiving the Session Start Request, the BSC/RNC gets the information of MBMS service area, namely the geographical information of Area1, in the Session Start Request first; then, determines whether the geographical area covered by its own covering cells includes the obtained area indicated by the information of MBMS service area, that is to say, the BSC/RNC determines whether the geographical area covered by its own covering cells includes Area1. If it includes Area1, the BSC/RNC builds the corresponding Iu bearer plane with the SGSN, builds the Iub bearer with the corresponding Node B and builds the radio bearer resources in the corresponding cells. In this embodiment, other unqualified conditions such as the abnormal conditions of Iu Flax and network failure, do not exist in the default case, that is to say, apart from the absence of a containing relation, no other abnormal conditions exist.

35) After the Iu bearer plane, the Iub bearer and the corresponding radio bearer resources have been built, when the content provider provides the i^{th} MBMS session, the service data are transmitted through a series of built bearers and resources at a rate of 64 kbps, and transmitted only in the cells of Area1,.

In the second application example, provided that the BM-SC needs to send the j^{th} MBMS session of the MBMS download service in the central area, Area2. Based on the comprehensive conditions of the radio network, the BM-SC needs to perform a data transmission of 128 kbps in Area2. Then, the MBMS service data transmission procedure for the MBMS download service is fully the same as the i^{th} MBMS session.

In the third application example, provided that the BM-SC needs to send the k^{th} MBMS session of the MBMS download service in the central area, Area3. Based on the comprehensive conditions of the radio network, the BM-SC needs to perform a data transmission of 384 kbps in Area3. Then, the MBMS service data transmission procedure for the MBMS download service is also fully the same as the i^{th} MBMS session.

Provided that there are three MBMS sessions, namely i, j and k, and their transmission rates are 384 kbps, 90kbps and 30 kbps, respectively. As the BM-SC has saved the corresponding network configuration when network planning is made, based on the network topology as shown in FIG. 8, the BM-SC needs to transmit the i^{th} MBMS session in the covering area of the WCDMA network, so the BM-SC sends a Session Format Instruction including the QoS information required by the session to the content provider, the content provider sends the multicast data at a rate of 384 kbps according to the QoS information. Likewise, the BM-SC needs to transmit the j^{th} MBMS session in the covering area of the EDGE network, so the BM-SC sends to the content provider a Session Format Instruction which includes the QoS information required by the session asking the content provider to send the multicast data at a rate of 90kbps. Under the similar circumstances, the BM-SC needs to transmit the k^{th} MBMS session in the covering area of the GPRS network, so the BM-SC sends to the content provider a Session Format Instruction which includes the QoS information required by the session asking the content provider to send the multicast data at a rate of 30 kbps.

If both the conditions shown in FIG. 7 and FIG. 8 exist when data of an MBMS service are transmitted in a city's communications network as shown in FIG. 7 or FIG. 8, for example, the core area shown in FIG. 8 is covered by the WCDMA network in which data of 384 kbps can be transmitted, and meanwhile the area is an area of service congestion as shown in FIG. 7 in which the bandwidth used for transmitting the MBMS service data is only 64 kbps. In this case, it is necessary to take various conditions into consideration in a comprehensive way so as to determine the data transmission rates in the corresponding area. Usually, the data are transmitted at a smaller rate.

### Embodiment 3

If what needs to be transmitted is a segment of news broadcast, a content provider can provide two kinds of session. One is a video+audio stream media session with a bandwidth of 128 kbps and the other is an audio session with a bandwidth of 30 kbps. Also as shown in FIG. 7, the bandwidth which can be used for the MBMS service data transmission in Area1 is 64 kbps; the bandwidth which can be used for the MBMS service data transmission in Area2 is 128 kbps; and the bandwidth which can be used for the MBMS service data transmission in Area3 is 384 kbps;

Then, the BM-SC needs to transmit the i^{th} MBMS session of the MBMS service for transmitting the news broadcast in Area1. Based on the current condition of the radio network, the BM-SC will perform an audio session transmission of 30 kbps in Area1, and the specific procedure is as follows.

41) The BM-SC sends to the content provider a Session Format Instruction, which instructs the content provider to provide an audio session of 30 kbps. Upon receiving the Session Format Instruction, the content provider returns a corresponding Session Format Acknowledgment.

42)˜44) are fully the same as the steps 32)˜34) in Embodiment 2.

45) After the Iu bearer plane, the Iub bearer and the corresponding radio bearer resources have been built, when the content provider provides the i^{th} MBMS session which is an audio session of a rate of 30 kbps, the service data are transmitted through a series of built bearers and resources and are transmitted only in the cells of Area1.

Similarly, the BM-SC needs to transmit the j^{th} MBMS session of the MBMS service for transmitting the news broadcast in Area2 and Area3. Based on the current conditions of the radio network, the BM-SC will perform a video+audio session transmission of 128 kbps in Area2 and Area3, and the transmission procedure is fully the same as the steps 41)˜45) of the i^{th} session.

After the Iu bearer plane, the Iub bearer and the corresponding radio bearer resources have been built, when the content provider provides the j^{th} MBMS session which is a video+audio session of a rate of 128 kbps, the service data are transmitted through a series of built bearers and resources, and are transmitted only in the cells of Area1 and Area2.

It is necessary to note that the case that BM-SC trigger the Session Start Request is also adaptive to the implementing manner of the above-mentioned embodiments, and when BM-SC trigger the Session Start Request by itself, the information of MBMS service area is stored in the BM-SC, and the other procedures is same to the above-mentioned procedures.

The embodiment of the present invention also provides a system for implementing the above-mentioned method, which includes a BM-SC, a GGSN, a SGSN, BSC/RNC.

The foregoing descriptions are only preferred embodiments of this invention and are not for use in limiting the protection scope thereof. Any changes and modifications can be made by those skilled in the art without departing from the spirit of this invention and therefore should be covered within the protection scope as set by the appended claims.

What is claimed is:

1. A method for transmitting Multimedia Broadcast/Multicast Service (MBMS) data, comprising:
sending, by a Broadcast/Multicast-Service Center (BM-SC), a Session Start Request with information of an MBMS service area to a Base Station Controller/Radio Network Controller (BSC/RNC) through a Gateway GPRS Support Node (GGSN) and a Serving GPRS Support Nodes (SGSN) of a core network;
receiving the Session Start Request by the BSC/RNC, and building an Iu bearer plane by the core network and the BSC/RNC whose covering area overlaps the MBMS service area in the Session Start Request;
allocating transmission resources for a data transmission of a MBMS service by the BSC/RNC whose covering area overlaps the MBMS service area in the Session Start Request, so as to provide the MBMS service to a user terminal.

2. The method of claim 1, wherein the Session Start Request with information of the MBMS service area which is sent by the BM-SC through the GGSN and the SGSN of a core network is different in the different sessions of one MBMS service.

3. The method of claim 2, further comprising:
before sending the Session Start Request to the BSC/RNC by the BM-SC, sending the Session Start Request to the BM-SC by a content provider, wherein the Session Start Request bears information of the MBMS service area.

4. The method of claim 2, wherein said sending the Session Start Request to the BSC/RNC by the BM-SC comprises:
providing the information of the MBMS service area to a server storing the network configuration by the BM-SC; comparing the geographical information in the information of the MBMS service area with the covering area of a radio network by the server to obtain a list of cells of the radio network corresponding to the information of the MBMS service area; returning the list of cells of the radio network to the BM-SC;
sending the Session Start Request with the list of cells to the GGSN by the BM-SC; upon receiving the Session Start Request, sending the Session Start Request with the list of cells to the SGSN by the GGSN; upon receiving the Session Start Request, sending the Session Start Request to all the BSC/RNCs connected with the SGSN;
wherein said building the Iu bearer plane by the core network and the BSC/RNC whose covering area overlaps the MBMS service area in the Session Start Request comprises:
determining by the BSC/RNC whether the list of cells in the Session Start Request overlaps the geographical information corresponding to a covering area of the BSC/RNC upon receiving the Session Start Request, if overlapping, building the Iu bearer plane by the core network and the BSC/RNC.

5. The method of claim 3, wherein said sending the Session Start Request to the BSC/RNC by the BM-SC comprises:
providing the information of the MBMS service area to a server storing the network configuration by the BM-SC; comparing the geographical information in the information of the MBMS service area with the covering area of a radio network by the server to obtain a list of cells of the radio network corresponding to the information of the MBMS service area; returning the list of cells of the radio network to the BM-SC;
sending the Session Start Request with the list of cells to the GGSN by the BM-SC; upon receiving the Session Start Request, sending the Session Start Request with the list of cells to the SGSN by the GGSN; upon receiving the Session Start Request, sending the Session Start Request to all the BSC/RNCs connected with the SGSN;
wherein said building the Iu bearer plane by the core network and the BSC/RNC whose covering area overlaps the MBMS service area in the Session Start Request comprises:
determining by the BSC/RNC whether the list of cells in the Session Start Request overlaps the geographical information corresponding to a covering area of the BSC/RNC upon receiving the Session Start Request, if overlapping, building the Iu bearer plane by the core network and the BSC/RNC.

6. The method of claim 4, further comprising:
upon receiving the Session Start Request with the list of cells, determining by the SGSN whether a covering area of itself contain a cell in the list of cells, if containing, sending the Session Start Request to all the BSC/RNCs connected with the SGSN.

7. The method of claim 5, further comprising:
upon receiving the Session Start Request with the list of cells, determining by the SGSN whether a covering area of itself contain a cell in the list of cells, if containing, sending the Session Start Request to all the BSC/RNCs connected with the SGSN.

8. The method of claim 2, wherein said sending the Session Start Request to the BSC/RNC by the BM-SC comprises:
sending the Session Start Request with the information of the MBMS service area to the GGSN by the BM-SC; upon receiving the Session Start Request, sending the Session Start Request with the information of the MBMS service area to the SGSN by the GGSN; upon receiving the Session Start Request, sending the Session Start Request with the information of the MBMS service area to all the BSC/RNCs connected with the SGSN;
wherein said building the Iu bearer plane by the core network and the BSC/RNC whose covering area overlaps the MBMS service area in the Session Start Request comprises:
determining by the BSC/RNC whether the information of the MBMS service area in the Session Start Request overlaps the geographical information corresponding to a covering area of the BSC/RNC upon receiving the Session Start Request, if overlapping, building the Iu bearer plane by the core network and the BSC/RNC.

9. The method of claim 3, wherein said sending the Session Start Request to the BSC/RNC by the BM-SC comprises:
sending the Session Start Request with the information of the MBMS service area to the GGSN by the BM-SC; upon receiving the Session Start Request, sending the Session Start Request with the information of the MBMS service area to the SGSN by the GGSN; upon receiving the Session Start Request, sending the Session Start Request with the information of the MBMS service area to all the BSC/RNCs connected with the SGSN;
wherein said building the Iu bearer plane by the core network and the BSC/RNC whose covering area overlaps the MBMS service area in the Session Start Request comprises:
determining by the BSC/RNC whether the information of the MBMS service area in the Session Start Request overlaps the geographical information corresponding to a covering area of the BSC/RNC upon receiving the Session Start Request, if overlapping, building the Iu bearer plane by the core network and the BSC/RNC.

10. The method of claim 5, further comprising:
before said sending the Session Start Request to the BM-SC by the content provider, sending a required Session Format Instruction to the content provider by the BM-SC; upon receiving the instruction, returning a Session Format Acknowledgment to the BM-SC by the content provider.

11. The method of claim 9, further comprising:
before said sending the Session Start Request to the BM-SC by the content provider, sending a required Session Format Instruction to the content provider by the BM-SC; upon receiving the instruction, returning a Session Format Acknowledgment to the BM-SC by the content provider.

12. The method of claim 10, wherein the Session Format Instruction comprises at least one of the following: an MBMS service identifier, QoS of service data of the MBMS session, session format information.

13. The method of claim 11, wherein the Session Format Instruction comprises at least one of the following: an MBMS service identifier, QoS of service data of the MBMS session, session format information.

14. The method of claim 10, further comprising:
before sending the Session Format Instruction to the content provider, obtaining by the BM-SC information of network topology of an access network corresponding to certain transmitting capability.

15. The method of claim 11, further comprising:
before sending the Session Format Instruction to the content provider, obtaining by the BM-SC information of network topology of an access network corresponding to certain transmitting capability.

16. The method of claim 14, further comprising:
before sending the Session Start Request to the core network by the BM-SC, making a intersection between the information of network topology of the access network and the information of the MBMS service area so as to obtain the information of the MBMS service area for a current session.

17. The method of claim 15, further comprising:
before sending the Session Start Request to the core network by the BM-SC, making a intersection between the information of network topology of the access network and the information of the MBMS service area so as to obtain the information of the MBMS service area for a current session.

18. The method of claim 14, wherein the obtained information of network topology of an access network comprises: the network topology information obtained by BM-SC according to the current load condition of each cell, which is reported by the BSC/RNC periodically or in the manner required by the BM-SC; or the network topology information obtained by the BM-SC from the network configuration information which is stored when the BM-SC makes network planning; or the network topology information which is obtained by the BM-SC via getting the planned network topology information and the cell load topology information respectively and getting the intersection between the two network topology, and the intersection is the network topology information.

19. The method of claim 15, wherein the obtained information of network topology of an access network comprises: the network topology information obtained by BM-SC according to the current load condition of each cell, which is reported by the BSC/RNC periodically or in the manner required by the BM-SC; or the network topology information obtained by the BM-SC from the network configuration information which is stored when the BM-SC makes network planning; or the network topology information which is obtained by the BM-SC via getting the planned network topology information and the cell load topology information respectively and getting the intersection between the two network topology, and the intersection is the network topology information.

20. The method of claim 1, wherein the Session Start Request with information of an MBMS service area sent by the BM-SC bears a network type identifier of access network;
the SGSN receives the Session Start Request and sends the Session Start Request to a network entity corresponding to the network type identifier of access network.

21. The method of claim 20, wherein the SGSN receiving the Session Start Request and sending the Session Start Request to a network entity corresponding to the network type identifier of access network comprises:
determining, by the SGSN, the network type identifier of access network in the Session Start Request, if the network type identifier of access network indicates a 2G network, sending, by the SGSN, the Session Start Request to the BSC connected with the SGSN; if the network type identifier of access network indicates a 3G network, sending, by the SGSN, the Session Start Request to the RNC connected with the SGSN; if the network type identifier of access network indicates a 2G network and a 3G network, sending, by the SGSN, the Session Start Request to the BSC and RNC connected with the SGSN.

22. The method of claim 1, wherein the Session Start Request with information of an MBMS service area sent by the BM-SC bears the network type identifier of access network;
the BSC/RNC which receives the Session Start Request determines whether it is of the access network type required by the session; if the BSC/RNC is not of the access network type, terminate a current process; otherwise, proceed to a subsequent operation.

23. The method of claim 3, wherein the Session Start Request with information of an MBMS service area sent by the BM-SC bears the network type identifier of access network;
the SGSN receives the Session Start Request and send the Session Start Request to a network entity corresponding to the network type identifier of access network.

24. The method of claim 23, wherein the Session Start Request with information of an MBMS service area sent by the content provider bears the network type identifier of access network.

25. The method of claim 10, wherein the Session Start Request with information of an MBMS service area sent by the BM-SC bears the network type identifier of access network;
the SGSN receives the Session Start Request and sends the Session Start Request to a network entity corresponding to the network type identifier of access network.

26. The method of claim 11, wherein the Session Start Request with information of an MBMS service area sent by the BM-SC bears the network type identifier of access network;
the SGSN receives the Session Start Request and sends the Session Start Request to a network entity corresponding to the network type identifier of access network.

27. A system for transmitting Multimedia Broadcast/Multicast Service (MBMS) data, comprising:
a Broadcast/Multicast-Service Center (BM-SC) for sending a Session Start Request to a Base Station Controller/Radio Network Controller (BSC/RNC) through a Gateway GPRS Support Node (GGSN) and a Serving GPRS Support Nodes (SGSN) of a core network;
the GGSN for receiving the Session Start Request from the BM-SC, and forwarding the Session Start Request to the SGSN;
the SGSN for receiving the Session Start Request from the GGSN, and sending the Session Start Request to the BSC/RNC;
the BSC/RNC for building an Iu bearer plane and allocating transmission resources for a data transmission of a MBMS service according to the Session Start Request;
wherein the BM-SC is configure to obtain information of an MBMS service area, and send the information of an MBMS service area to the BSC/RNC through the core network;
and the BSC/RNC builds the Iu bearer plane and allocates transmission resources for the data transmission of the MBMS service according to the information of the MBMS service area and a covering area of itself.

28. The system of claim 27, wherein the BM-SC sends the different Session Start Request with information of the MBMS service area through the GGSN and the SGSN of the core network in the different sessions of one MBMS service.

29. The system of claim 27, wherein the BM-SC obtains a network type identifier of access network, and sends the network type identifier of access network to the BSC/RNC through the GGSN and the SGSN of the core network;
the BSC/RNC receives the Session Start Request, and determines whether it is of the access network type required by the session; if the BSC/RNC is not of the access network type, terminating a current process; otherwise, proceeding to a subsequent operation.

30. The system of claim 27, wherein the BM-SC obtains the network type identifier of access network, and sends the network type identifier of access network to the SGSN;
the SGSN determines the network type identifier of access network in the Session Start Request, if the network type identifier of access network indicates a 2G network, the SGSN sends the Session Start Request to the BSC connected with the SGSN; if the network type identifier of access network indicates a 3G network, the SGSN sends the Session Start Request to the RNC connected with the SGSN; if the network type identifier of access network indicates a 2G network and a 3G network, the SGSN sends the Session Start Request to the BSC and RNC connected with the SGSN.

31. The system of claim 27, further comprising:
a content provider for sending the Session Start Request bearing the information of the MBMS service area to the BM-SC.

32. The system of claim 27, wherein the BM-SC obtains the network topology information, and makes an intersection between the network topology information and the information of the MBMS service area, and sends the intersection as information of service area to the BSC/RNC.

33. The system of claim 27, further comprising:
a server storing the network configuration, which receives the information of the MBMS service area provides by the BM-SC; and compares the geographical information in the information of the MBMS service area with the covering area of itself to obtain a list of cells of radio network corresponding to the information of the MBMS service area; and returns the list of cells of radio network to the BM-SC;
the BM-SC sends the list of cells of radio network corresponding to the information of the MBMS service area to the BSC/RNC;
the BSC/RNC builds an Iu bearer plane, and allocates transmission resources according to the list of cells of radio network corresponding to the information of the MBMS service area and information of covering area of the BSC/RNC.
